(19) United States
(12) Patent Application Publication
(10) Pub. No.: US 2008/0126795 A1
(43) Pub. Date: May 29, 2008

(54) METHOD, SYSTEM, AND APPARATUS FOR TRANSMITTING SYSLOG PROTOCOL MESSAGES

(75) Inventor: Fuyou Miao, Shenzhen (CN)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Huawei Technologies Co., Ltd., Shenzhen (CN)

(21) Appl. No.: 11/952,286

(22) Filed: Dec. 7, 2007

Related U.S. Application Data
(63) Continuation of application No. PCT/CN2006/003480, filed on Dec. 19, 2006.

(30) Foreign Application Priority Data
Apr. 19, 2006 (CN) 200610076225.0

(51) Int. Cl. H04L 9/00

(52) U.S. Cl. 713/151

(57) ABSTRACT

The present invention provides a method, a system and an apparatus for transmitting SYSLOG messages. The method includes: transmitting a secure transmission upgrade indication from a SYSLOG message sender to a SYSLOG message receiver; establishing a secure transmission connection on the transport layer connection currently utilized between the message sender and the message receiver; and transmitting the SYSLOG messages between the message sender and message receiver via the secure transmission connection. The system mainly includes the message sender and the message receiver. The present invention enables the transmission of SYSLOG messages to switch between the secure transmission and the transport layer transmission, thus saves system resources while guaranteeing the security of private information.

### FIELD OF THE INVENTION

The present invention relates to communication technologies, and particularly to a method, a system and an apparatus for transmitting SYSLOG messages.

### BACKGROUND OF THE INVENTION

SYSLOG protocol is an event notification transferring protocol widely adopted in a variety of network operation systems. Existing popular operation systems, such as Microsoft Windows system, different kinds of UNIX systems and Linux systems have implemented the SYSLOG protocol.

The SYSLOG protocol adopts a Client/Server mode in communications. A Client is the sender of event messages, and a Server is the receiver of the event messages. The Client may be an event generator, e.g. a device or a process; the client may also be a relay entity which processes a SYSLOG message from a sender (an event generator or another relay entity) and transmits the SYSLOG message to a receiver.

The SYSLOG protocol provides a unidirectional communication, i.e. the event messages are transmitted from the sender to the receiver, whereas the receiver does not return to the sender any messages, such as a confirmation message, a connection initiation message, or a connection close message, on the SYSLOG protocol layer.

The SYSLOG protocol is a text-based protocol. According to the SYSLOG protocol, all parameter names and parameter values are in the form of text, and characters whose code values are lower than 32 in ASCII code are avoided, i.e. control characters are avoided. Therefore, a SYSLOG message may be simply regarded as a text block from the view of transmission protocols of lower layers.

The format of a SYSLOG message is described as follows.

1) A SYSLOG message includes a header, structured data and a message (MSG).

2) The header includes a string composed of print characters, and the print characters include the following fields separated by spaces:

PRI, a priority level;

VERSION, a version number of the SYSLOG protocol;

TIMESTAMP, a time stamp;

HOSTNAME, a name of a host;

APP-NAME, a name of an application;

PROCID, an ID of a process; and

MSGID, an ID of the message.

3) The structured data consists of a series of structured elements, each of which includes a structured element name and multiple parameter name/value pairs.

4) The MSG is a message consisting of print characters, usually used for describing an event.

User Datagram Protocol (UDP) is usually used for transmitting SYSLOG messages. According to the relation between the length of the SYSLOG message and the length of the UDP message, the UDP message may carry only one SYSLOG message while transmitting the SYSLOG message using UDP. Part A of FIG. 1 illustrates the protocol hierarchy in the protocol stack structure of the SYSLOG protocol when UDP is adopted for transmitting the SYSLOG message.

Despite of its simplicity and flexibility, UDP is an unreliable connectionless protocol. Packet loss may occur during the transmission process of the SYSLOG packet with UDP adopted, and SYSLOG does not deal with the packet loss; therefore, the adoption of UDP to transmit the SYSLOG message may cause event information loss in the transmission. Transfer control protocol (TCP) is a reliable connection-oriented protocol and can be adopted for transmitting the SYSLOG message to improve the reliability of data transmission. Part B of FIG. 1 illustrates the protocol hierarchy in the protocol stack structure of the SYSLOG protocol when TCP is adopted for transmitting the SYSLOG message.

Internet security is more and more crucial to the steady operation of the network at present; similarly, the SYSLOG protocol also faces the following security problems:

1) Information Falsification

The SYSLOG message is falsified by a malice network node during the transmission;

2) Information Leakage

The SYSLOG message is intercepted illegally during the transmission, and information in the SYSLOG message, e.g. the description information of an event, is leaked;

3) Identity Counterfeiting

A malice node imitates a legal node to join the SYSLOG communication.

Therefore, for the security of the SYSLOG message, the SYSLOG message may be transmitted over some security protocols, e.g. the Transport Layer Security (TLS) protocol, the Blocks Extensible Exchange Protocol (BEEP) and the Secure Shell (SSH) protocol, which provide security protection mechanisms including confidentiality, integrity and data source verification so that the security of the SYSLOG message can be ensured. Part C of FIG. 1 illustrates the protocol hierarchy in the protocol stack structure of the SYSLOG protocol when TCP and a security protocol is adopted for transmitting the SYSLOG message.

Many devices and log servers have implemented the TCP-based transmission and the secure transmission at present. According to a method for transmitting the SYSLOG message with TLS in the prior art, a TLS transmission mode is configured to be a default mode. When a SYSLOG request is initiated to a specific TCP port, it is deemed that all the SYSLOG messages on the TCP connection need TLS protection. Therefore, TLS handshake process is directly launched after the TCP connection is established, and the SYSLOG messages are transmitted over the TLS protocol after the handshake process is completed. All SYSLOG messages on the TCP connection are transmitted with TLS until the communication is terminated.

The above-mentioned method is disadvantageous in that in practical applications, some devices or log servers expect to transmit only a specific group of the SYSLOG messages, instead of all SYSLOG messages, with security protocols, and transmit the other SYSLOG messages with the TCP connection without security protocol after a specific group of the SYSLOG messages are transmitted.

According to another method in the prior art, TCP and TLS alternate to transmit the SYSLOG message transmission, and a step of re-establishing connections is adopted. The process includes:

1) establishing a TCP connection for transmitting SYSLOG message;

2) closing the TCP connection when private SYSLOG messages need to be transmitted, and establishing a TCP/TLS connection for transmitting the private SYSLOG messages;

3) closing the TCP/TLS connection after completing the transmission of the private SYSLOG messages, and establishing a new TCP connection to continue transmitting the ordinary SYSLOG message.

The above-mentioned method is disadvantageous in that multiple establishments and closures of connections waste system resources.

### SUMMARY OF THE INVENTION

A method for transmitting SYSLOG messages, includes:

transmitting a secure transmission upgrade indication from a SYSLOG message sender to a SYSLOG message receiver;

establishing a secure transmission connection on a transport layer connection currently utilized between the SYSLOG message sender and the SYSLOG message receiver; and

transmitting SYSLOG messages from the SYSLOG message sender to the SYSLOG message receiver via the secure transmission connection.

An apparatus for transmitting SYSLOG messages, includes:

an upgrade indication transmission module, configured to transmit a secure transmission upgrade indication; and

a SYSLOG message secure transmission module, configured to establish a secure transmission connection on a transport layer connection currently utilized after the upgrade indication transmission module has sent the secure transmission upgrade indication, and transmit SYSLOG messages via the secure transmission connection.

An apparatus for receiving SYSLOG messages, includes:

an upgrade indication receiving module, configured to receive a secure transmission upgrade indication; and

a SYSLOG message secure receiving module, configured to establish a secure transmission connection on a transport layer connection currently utilized after the upgrade information receiving module has received the secure transmission indication, and receive SYSLOG messages via the secure transmission connection.

A system for transmitting SYSLOG messages, including a message sender and a message receiver, wherein:

the message sender is configured to transmit a secure transmission upgrade indication to the message receiver, establish together with the message receiver a secure transmission connection on a transport layer connection currently utilized, and transmit SYSLOG messages via the secure transmission connection to the message receiver; and

the message receiver is configured to receive the secure transmission upgrade indication from the message sender, establishes together with the message sender the secure transmission connection on the transport layer currently utilized, and receive the SYSLOG messages via the secure transmission connection from the message sender.

### BRIEF DESCRIPTION OF THE DRAWINGS

FIG. 1 is a schematic diagram illustrating a protocol stack structure of the SYSLOG protocol;

FIG. 2 is a flowchart illustrating the method according to an embodiment of the present invention;

FIG. 3 is a schematic diagram illustrating a protocol stack structure in the TCP/TLS upgrade and rollback process according to an embodiment of the present invention;

FIG. 4 is a schematic diagram illustrating a structure of the system according to an embodiment of the present invention.

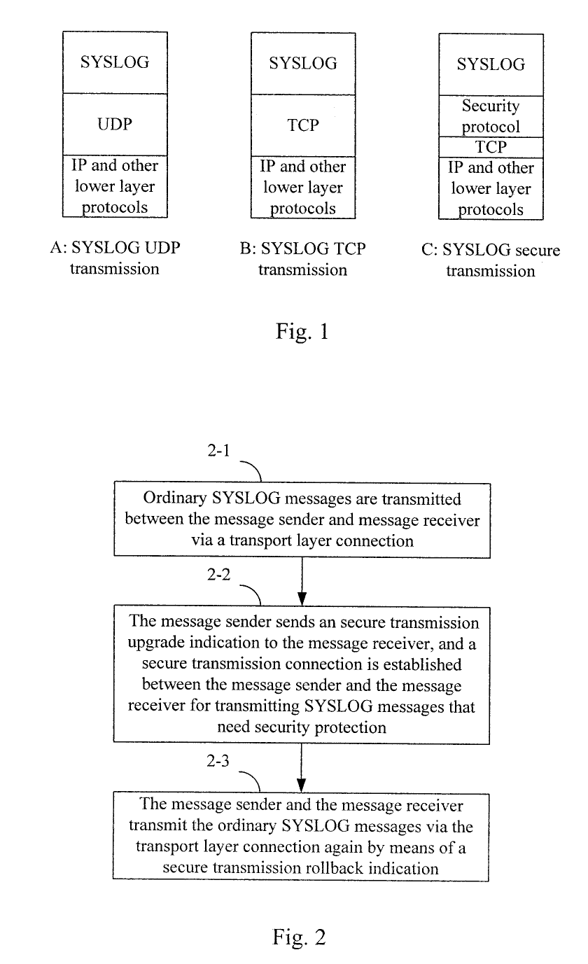

### DETAILED DESCRIPTION OF THE INVENTION

Embodiments of the present invention are described as follows in detail with reference to the accompanying drawings. As shown in FIG. 2, the work flow of the method in accordance with an embodiment of the present invention includes:

Block 2-1: Ordinary SYSLOG messages are transmitted between the message sender and message receiver via a transport layer connection.

First a transport layer connection, e.g. a TCP connection is established between the message sender and the message receiver. The ordinary SYSLOG messages that need not protection can be transmitted between the message sender and the message receiver via the TCP connection; in other words, the ordinary SYSLOG messages are transmitted directly with TCP.

Block 2-2: The message sender transmits a secure transmission upgrade indication to the message receiver, and a secure transmission connection is established between the message sender and the message receiver to transmit the SYSLOG messages that need security protection.

When private SYSLOG messages that need security protection are to be transmitted between the message sender and the message receiver, the message sender transmits a secure transmission upgrade indication, which may be carried in a secure transmission upgrade message, to the message receiver.
The secure transmission upgrade message may adopt either of the following formats.

1) A special application layer message

The special application layer message is not consistent with the SYSLOG message in format, but it carries an upgrade indication.

2) A special SYSLOG message

The special SYSLOG message is consistent with the SYSLOG message in format, but it has a specified field used for containing the upgrade indication so that the message receiver performs upgrade upon receiving the special SYSLOG message.

For example, some irregular values may be set in the header of the special SYSLOG message. For instance, an irregular value in the PRI field may be set to serve as the upgrade indication, so that the message receiver performs upgrade when having detected that the PRI field of the received SYSLOG message contains the irregular value.

3) A special SYSLOG message

The special SYSLOG message contains some predetermined structured data element in the structured data section; and the upgrade indication is carried in the identity of the structured data element or in the parameter name/value pair of the predetermined structured data element. The message receiver performs upgrade when having detected that the structured data of the received SYSLOG message contains the identity or the parameter name/value pair;

4) An ordinary SYSLOG message

The ordinary SYSLOG message, while transmitting ordinary event information, contains some predetermined structured data element in the structured data section; and the upgrade indication is carried in the identity of the structured data element or in the parameter name/value pair of the predetermined structured data element. The message receiver performs upgrade when having detected that the structured data of the received SYSLOG message contains the identity or the parameter name/value pair.

Upon receiving the secure transmission upgrade message, the message receiver establishes with the message sender a secure transmission connection, e.g. a TLS connection, on the transport layer connection currently utilized. Meanwhile, the message sender does not close the established TCP connection, but initiates a TLS handshake process with the message receiver over the TCP connection, and a TLS connection over the TCP connection is established between the message sender and the message receiver after the TLS handshake process is completed. If there is an existing TLS connection between the message sender and the message receiver, the TLS handshake process is omitted.

The TLS protocol is a security protocol over secure transmission connection and offers security services including verification, integrity check, data confidentiality and anti-playback, etc. The TLS protocol is widely adopted in network accesses. However, other security protocols may also be adopted, such as the BEEP protocol or the SSH protocol.

After the establishment of the TLS connection, the following private SYSLOG messages that need security protection are transmitted via the TLS connection. The established TCP connection is not closed when the TLS connection is used for transmitting SYSLOG messages.

### Block 2-3: By transmitting a secure transmission rollback indication, the message sender and receiver use the transport layer connection again to transmit the ordinary SYSLOG messages.

After the private SYSLOG messages that need security protection are transmitted, the message sender transmits a rollback indication, which may be carried in a secure transmission rollback message, to the message receiver.

In correspondence with the secure transmission upgrade message, the secure transmission rollback message may adopt either of the following formats.

1) A special application layer message

The special application layer message is not consistent with the SYSLOG message in format, but it carries a rollback indication. The message receiver performs rollback upon receiving the special application layer message;

2) A special SYSLOG message

The special SYSLOG message is consistent with the SYSLOG message in format, but it has a specified field indicating that the special SYSLOG message serves as the security transmission rollback message.

For example, some irregular values may be set in the header of the special SYSLOG message. For instance, an irregular value in the PRI (priority) field may be set to serve as the rollback indication, so that the message receiver performs rollback when having detected that the PRI field of the received SYSLOG message contains the irregular value;

3) A special SYSLOG message

The special SYSLOG message contains some predetermined structured data element in the structured data section; and the rollback indication is carried in the identity of the structured data element or in the parameter name/value pair of the predetermined structured data element. The message receiver performs rollback when having detected that the structured data of the received SYSLOG message contains the identity or the parameter name/value pair;

4) An ordinary SYSLOG message

The ordinary SYSLOG message, while transmitting ordinary event information, contains some predetermined structured data element in the structured data section; and the rollback indication is carried in the identity of the structured data element or in the parameter name/value pair of the predetermined structured data element. The message receiver performs rollback when having detected that the structured data of the received SYSLOG message contains the identity or the parameter name/value pair.

When the message sender has transmitted the secure transmission rollback message, the following SYSLOG messages continue to be transmitted over the TCP connection, and the TLS connection may or may not be closed on demand.

If the secure transmission connection between the message sender and the message receiver is not closed, when the message sender transmits another secure transmission upgrade indication to the message receiver, the message sender will use the secure transmission connection again to transmit SYSLOG messages to the message receiver.

If the secure transmission connection between the message sender and the message receiver is closed, when the message sender transmits another secure transmission indication to the message receiver, the message sender and the message receiver establish a new secure transmission connection on the transport layer connection currently utilized, and the message sender will use the new secure transmission connection to transmit SYSLOG messages to the message receiver.

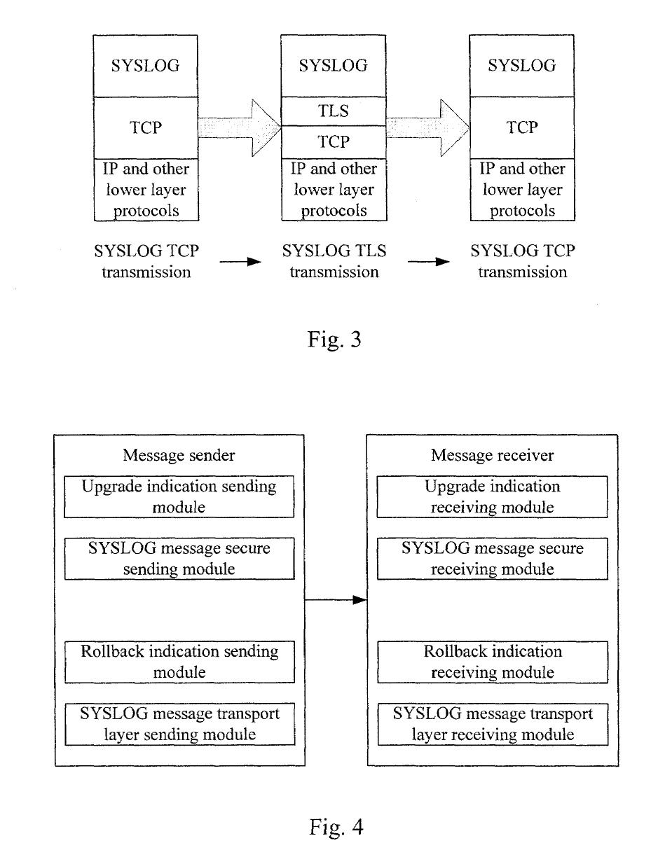

FIG. 3 shows the protocol stack structure in the TCP/TLS upgrade and rollback process.

As shown in FIG. 3, the message sender and the message receiver first transmit SYSLOG messages via the TCP connection; after the upgrade from the TCP connection to the TLS connection, the message sender and the message receiver transmit SYSLOG messages via the TLS connection without closing the TCP connection formerly established between the message sender and the message receiver; after the rollback from TLS connection to the TCP connection, the message sender and the message receiver continue with transmitting the SYSLOG messages over the TCP connection formerly established while the TLS connection is closed or maintained on demand.

FIG. 4 shows the structure of the system for transmitting SYSLOG messages according to an embodiment of the present invention. The system includes a message sender and a message receiver.

The message sender is configured to transmit a secure transmission upgrade indication to the message receiver, establish with the message receiver a secure transmission connection (e.g. TLS connection) on the transport layer connection (e.g. TCP connection) currently utilized, and transmits SYSLOG messages via the secure transmission connection to the message receiver. The message sender includes: an upgrade indication transmission module, a SYSLOG message secure transmission module, a rollback indication transmission module and a SYSLOG message transport layer transmission module.

The upgrade indication transmission module is configured to transmit a secure transmission upgrade indication from the message sender to the message receiver when private SYSLOG messages that need security protection are to be transmitted between the message sender and the message receiver, wherein the secure transmission upgrade indication is carried in a secure transmission upgrade message, such as an application layer message or a SYSLOG message.

The SYSLOG message secure transmission module is configured to establish together with the message receiver the secure transmission connection on the transport layer connection currently utilized between the message sender and the message receiver without closing the transport layer connection after the upgrade indication transmission module has sent the secure transmission indication to the message receiver, and transmit SYSLOG messages to the message receiver via the secure transmission connection.

The rollback indication transmission module is configured to transmit a secure transmission rollback indication from the message sender to the message receiver when ordinary SYSLOG messages that need not security protection are to be transmitted between the message sender and the message receiver, wherein the secure transmission rollback indication is carried in a secure transmission rollback message, such as an application layer message or a SYSLOG message.

The SYSLOG message transport layer transmission module is configured to transmit SYSLOG messages to the message receiver via the transport layer connection after the rollback indication transmission module has sent the secure transmission rollback indication to the message receiver. The SYSLOG message transport layer transmission module may be further configured to close the established secure transmission connection on demand.

The message receiver is configured to establish together with the message sender the secure transmission connection on the transport layer currently utilized after receiving the secure transmission indication from the message sender, and receive SYSLOG messages via the secure transmission connection from the message sender. The message receiver includes: an upgrade indication receiving module, a SYSLOG message secure receiving module, a rollback indication receiving module and a SYSLOG message transport layer receiving module.

The upgrade indication receiving module is configured to receive the secure transmission upgrade indication from the message sender.

The SYSLOG message secure receiving module is configured to establish together with the message sender the secure transmission connection on the transport layer connection currently utilized between the message sender and the message receiver without closing the transport layer connection after the upgrade information receiving module has received the secure transmission indication, and receive SYSLOG messages from the message sender via the secure transmission connection.

The rollback indication receiving module is configured to receive the secure transmission rollback indication from the message sender.

The SYSLOG message transport layer receiving module is configured to receive SYSLOG messages from the message sender via the transport layer connection after the rollback information receiving module has received the secure transmission rollback indication. The SYSLOG message transport layer receiving module may be further configured to close the established secure transmission connection on demand.

The apparatus for transmitting SYSLOG messages according to the embodiment of the present invention includes the message sender and the message receiver.

According to the embodiments of the present invention, transmission upgrade messages or transmission rollback messages are transmitted between the message sender and the message receiver, and the formerly-established transport layer connection, for example the TCP connection, is not closed when the SYSLOG messages are transmitted via the secure transmission connection such as the TLS connection. Therefore, the transmission of the SYSLOG messages may switch between the secure transmission and the transport layer transmission. When the SYSLOG message transmission returns from the secure transmission to the transport layer transmission, the transport layer connection established formerly can be used again without establishing a new transport layer connection, thus system resources can be saved while private information can be protected.

The above are only preferred embodiments of this invention. The protection scope of this invention, however, is not limited to the above description. Any modification or substitution, within the technical scope disclosed by this invention, easily occurring to those skilled in the art should be covered by the protection scope of this invention. Therefore, the protection scope of the present invention should be determined according to claims.

1. A method for transmitting SYSLOG messages, comprising:
transmitting a secure transmission upgrade indication from a SYSLOG message sender to a SYSLOG message receiver;
establishing a secure transmission connection on a transport layer connection currently utilized between the SYSLOG message sender and the SYSLOG message receiver; and
transmitting SYSLOG messages from the SYSLOG message sender to the SYSLOG message receiver via the secure transmission connection.

2. The method of claim 1, further comprising:
transmitting a secure transmission rollback indication from the SYSLOG message sender to the SYSLOG message receiver; and
transmitting SYSLOG messages from the SYSLOG message sender to the message receiver via the transport layer connection.

3. The method of claim 2, further comprising:
maintaining the secure transmission connection between the message sender and the message receiver; and
transmitting SYSLOG messages from the message sender to the message receiver via the secure transmission connection when another secure transmission upgrade indication is sent from the message sender to the message receiver.

4. The method of claim 2, further comprising:
closing the secure transmission connection between the message sender and the message receiver;
establishing a new secure transmission connection on the transport layer connection currently utilized when another secure transmission upgrade indication is sent from the message sender to the message receiver; and
transmitting SYSLOG messages from the message sender to the message receiver via the new secure transmission connection.

5. An apparatus for transmitting SYSLOG messages, comprising:
an upgrade indication transmission module, configured to transmit a secure transmission upgrade indication; and
a SYSLOG message secure transmission module, configured to establish a secure transmission connection on a transport layer connection currently utilized after the upgrade indication transmission module has sent the secure transmission upgrade indication, and transmit SYSLOG messages via the secure transmission connection.

6. The apparatus of claim 5, further comprising:
a rollback indication transmission module, configured to transmit a secure transmission rollback indication; and
a SYSLOG message transport layer transmission module, configured to transmit the SYSLOG messages via the transport layer connection after the rollback indication transmission module has sent the secure transmission rollback indication.

7. An apparatus for receiving SYSLOG messages, comprising:
an upgrade indication receiving module, configured to receive a secure transmission upgrade indication; and
a SYSLOG message secure receiving module, configured to establish a secure transmission connection on a transport layer connection currently utilized after the upgrade information receiving module has received the secure transmission indication, and receive SYSLOG messages via the secure transmission connection.

8. The apparatus of claim 7, further comprising:
a rollback indication receiving module, configured to receive a secure transmission rollback indication; and
a SYSLOG message transport layer receiving module, configured to receive the SYSLOG messages via the transport layer connection after the rollback indication receiving module has received the secure transmission rollback indication.

9. A system for transmitting SYSLOG messages, comprising a message sender and a message receiver, wherein:
the message sender is configured to transmit a secure transmission upgrade indication to the message receiver, establish together with the message receiver a secure transmission connection on a transport layer connection currently utilized, and transmit SYSLOG messages via the secure transmission connection to the message receiver; and
the message receiver is configured to receive the secure transmission upgrade indication from the message sender, establishes together with the message sender the secure transmission connection on the transport layer currently utilized, and receive the SYSLOG messages via the secure transmission connection from the message sender.

10. The system of claim 9, wherein the message sender comprises:
an upgrade indication transmission module, configured to transmit the secure transmission upgrade indication to the message receiver; and
a SYSLOG message secure transmission module, configured to establish together with the message receiver the secure transmission connection on the transport layer connection currently utilized between the message sender and the message receiver without closing the transport layer connection after the upgrade information transmission module has sent the secure transmission upgrade indication to the message receiver, and transmit the SYSLOG messages to the message receiver via the secure transmission connection.

11. The system of claim 10, wherein the message sender further comprises:
a rollback indication transmission module, configured to transmit the secure transmission rollback indication to the message receiver; and
a SYSLOG message transport layer transmission module, configured to transmit SYSLOG messages via the transport layer connection after the rollback indication transmission module has sent the secure transmission rollback indication, and close or maintain the established secure transmission connection.

12. The system of claim 9, wherein the message receiver further comprises:
an upgrade indication receiving module, configured to receive the secure transmission indication from the message sender; and
a SYSLOG message secure receiving module, configured to establishing together with the message sender the secure transmission connection on the transport layer connection currently utilized between the message sender and the message receiver without closing the transport layer connection after the upgrade information receiving module has received the secure transmission indication, and receive the SYSLOG messages from the message sender via the secure transmission connection.

13. The system of claim 12, wherein the message receiver further comprises:
a rollback indication receiving module, configured to receive the secure transmission rollback indication from the message sender; and
a SYSLOG message transport layer receiving module, configured to receive the SYSLOG messages via the transport layer connection after the rollback indication receiving module has received the secure transmission rollback indication, and close or maintain the established secure transmission connection.

14. The system of claim 10, wherein the message receiver further comprises:
an upgrade indication receiving module, configured to receive the secure transmission indication from the message sender; and
a SYSLOG message secure receiving module, configured to establishing together with the message sender the secure transmission connection on the transport layer connection currently utilized between the message sender and the message receiver without closing the transport layer connection after the upgrade information receiving module has received the secure transmission indication, and receive the SYSLOG messages from the message sender via the secure transmission connection.

15. The system of claim 14, wherein the message receiver further comprises:
a rollback indication receiving module, configured to receive the secure transmission rollback indication from the message sender; and
a SYSLOG message transport layer receiving module, configured to receive the SYSLOG messages via the transport layer connection after the rollback indication receiving module has received the secure transmission rollback indication, and close or maintain the established secure transmission connection.

16. The system of claim 11, wherein the message receiver further comprises:
an upgrade indication receiving module, configured to receive the secure transmission indication from the message sender; and
a SYSLOG message secure receiving module, configured to establishing together with the message sender the secure transmission connection on the transport layer connection currently utilized between the message sender and the message receiver without closing the transport layer connection after the upgrade information receiving module has received the secure transmission indication, and receive the SYSLOG messages from the message sender via the secure transmission connection.

17. The system of claim 16, wherein the message receiver further comprises:
a rollback indication receiving module, configured to receive the secure transmission rollback indication from the message sender; and
a SYSLOG message transport layer receiving module, configured to receive the SYSLOG messages via the transport layer connection after the rollback indication receiving module has received the secure transmission rollback indication, and close or maintain the established secure transmission connection.
